(19) United States
(12) Patent Application Publication
(10) Pub. No.: US 2016/0294944 A1
(43) Pub. Date: Oct. 6, 2016

(54) METHOD AND SYSTEM FOR REACH AND FREQUENCY CONTROL WHEN PRESENTING A SECOND VIDEO WITH ONE OR MORE FIRST VIDEOS

(71) Applicant: QDOS, Inc. d/b/a DeskSite, Irvine, CA (US)

(72) Inventor: Richard James Gillam, Irvine, CA (US)

(73) Assignee: QDOS, INC. D/B/A DESKSITE, Irvine, CA (US)

(21) Appl. No.: 14/706,806

(22) Filed: May 7, 2015

Related U.S. Application Data
(63) Continuation-in-part of application No. 14/677,543, filed on Apr. 2, 2015.

(51) Int. Cl. H04L 29/08; G06F 17/30; H04L 29/06

(52) U.S. Cl. CPC H04L 67/1095; H04L 67/1097; H04L 65/60; G06F 17/30846

(57) ABSTRACT

A system for reach and/or frequency control when presenting digital content comprises a first set of executable instructions configured to provide digital content stored on the server storage device to one or more user devices that are connected to a network. The first set of executable instructions are further configured to store one or more parameters for presenting the digital content. The one or more parameters include frequency control parameters. A second set of executable instructions are configured to be downloaded to each of the user devices to store the frequency control parameters on a client storage device for each user device, wherein the frequency control parameters are configured to be updated by the second set of downloaded instructions upon presentation of the digital content on the user devices regardless of whether the digital content is presented online or offline with respect to the network.

### CROSS-REFERENCE TO RELATED APPLICATIONS

This Application is a continuation-in-part of U.S. patent application Ser. No. 14/677,543, filed Apr. 2, 2015, the contents of which are incorporated in this disclosure by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention generally relates to a method and system for reach and frequency control when presenting a second video with one or more first videos. More specifically, the present invention relates to a system and method that transforms electronic data in a database to control the reach and frequency that users with electronic devices are collectively and individually presented with one or more second videos, regardless of online connectivity of each of those users.

### SUMMARY OF THE INVENTION

According to a preferred embodiment, a system for frequency control when presenting digital content comprises a server processor on a server device; a server storage device connected to the server device; a first set of executable instructions that are executable on the server processor configured to provide digital content stored on the server storage device to one or more user devices that are connected to a network, the first set of executable instructions further configured to store one or more parameters for presenting the digital content, the one or more parameters including frequency control parameters; a second set of executable instructions configured to be downloaded to each of the user devices to store the frequency control parameters on a client storage device for each user device, wherein the frequency control parameters are configured to be updated by the second set of downloaded instructions upon presentation of the digital content on the user devices regardless of whether the digital content is presented online or offline with respect to the network; and a third set of executable instructions configured to synchronize the frequency control parameters with each of the user devices, the second set of executable instructions further configured to synchronize the frequency control parameters when online.

According to another preferred embodiment, a method for frequency control when presenting digital content comprises: providing digital content stored on the server storage device to one or more user devices that are connected to a network storing one or more parameters for presenting the digital content, the one or more parameters including frequency control parameters; downloading instructions executable each of the user devices to store the frequency control parameters on a client storage device for each user device, wherein the frequency control parameters are configured to be updated by the set of downloaded instructions upon presentation of the digital content on the user devices regardless of whether the digital content is presented online or offline with respect to the network; and synchronizing the reach and frequency control parameters with each of the user devices, the second set of executable instructions further configured to synchronize the frequency control parameters when online.

According to yet another preferred embodiment, a system for reach control when presenting digital content comprises: a server processor on a server device; a server storage device connected to the server device; a first set of executable instructions that are executable on the server processor configured to provide digital content stored on the server storage device to a quantity of user devices that are connected to a network, the quantity of user devices based on a reach control parameter; and a second set of executable instructions configured to be downloaded to each of the user devices to present the digital content on the user devices regardless of whether the digital content is presented online or offline with respect to the network.

According to yet another preferred embodiment, a method for reach control when presenting digital content comprises: providing digital content stored on a server storage device to a quantity of user devices that are connected to a network, the quantity of user devices based on a reach control parameter; and downloading a set of executable instructions to each of the quantity of user devices to present the digital content on the user devices regardless of whether the digital content is presented online or offline with respect to the network.

### BRIEF DESCRIPTION OF THE DRAWINGS

FIG. 1 is a diagrammatic representation of an exemplary internet-based environment in which one embodiment may operate;

FIG. 2 is a diagrammatic representation of the components of one or more of the portable or stationary user devices having a local clock according to the embodiment of FIG. 1;

FIG. 3 is a diagrammatic representation of one or more of the user devices of FIGS. 1 and 2, and a storage device with a database containing electronic data that is transformed;

FIG. 4 is a flow chart illustrating steps performed by a video display software according to the embodiment of FIGS. 1-3;

FIG. 5 is a flow chart illustrating steps performed by video display software according to the embodiment of FIGS. 1-4; and

FIG. 6 is a diagrammatic representation of a server computer of FIG. 1 and a storage device with a database containing electronic data that is transformed.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

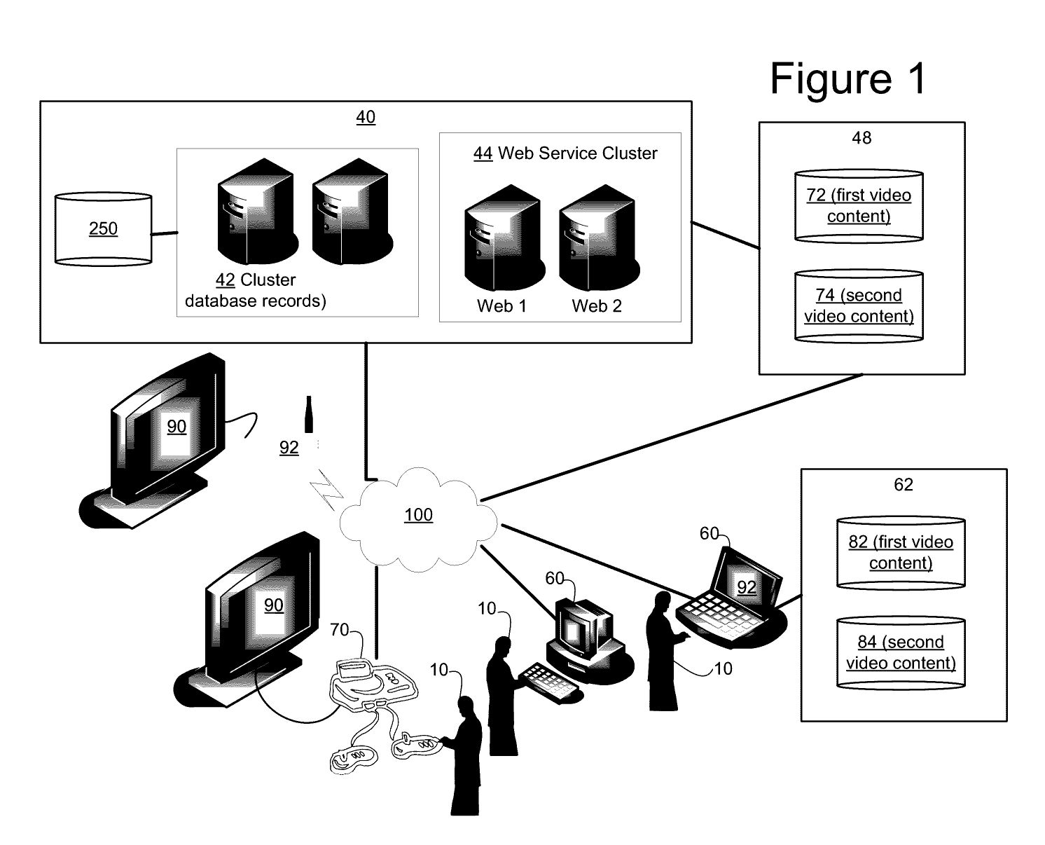

The method and system for reach and frequency control when presenting a second video with one or more first videos is disclosed in accordance with preferred embodiments of the present invention and is illustrated in FIGS. 1-6 wherein like reference numerals are used throughout to designate like elements.

In one embodiment, the term reach may mean the quantity of viewers who are presented with content, which may include for example, videos, banner advertisements, graphics, or the like. In another embodiment, the term frequency may mean the days, dates, and/or times on which such content may be presented. In one embodiment, the term reach may comprise unique users who are unauthenticated (not required to register or login) to a system, server, or device, but are still able to be counted by the system and method described herein. Just one advantage of some embodiments is the ability to control and/or track the number of unique users who are presented with the content without the need for authentication, login, local cookies, or the like.

With reference to FIG. 1, a diagrammatic representation of an exemplary internet-based system is shown in which the system and method may operate according to one embodiment. As is typical on today's internet 100, users 10 may connect to and use the internet 100 over several platforms. Those platforms may include personal computers 60, mobile phones, tablets, or the like. One of the latest ways to connect to the internet includes using internet protocol television, or IPTV, boxes 92. These IPTV boxes 92 include a wireless or wired device that has a memory and storage for applications or apps that connects to the internet 100. Through an IPTV box 92, users may use the apps contained therein to display videos, pictures, and internet sites on a television (TV) 90. The television is typically connected to the IPTV box 92 via an HDMI cord, component cable, or audio/video (A/V) input lines.

Further, modern game consoles 70 are now capable of video play. Game consoles 70 such as the XBOX®, Playstation®, Nintendo®, Wii®, and others, provide for internet video presentation. Just as with the IPTV box 92, game consoles 70 typically connect to a TV 90 on which the video may be viewed.

What may be common among all of these user devices 60, 92, 70 is that they typically have their own internal digital clocks that may be set to the local time of the user 10 who is using the device. For example, a user 10 in Los Angeles, Calif., may be using a device 60 with the internal clock set to 12:00 pm Pacific Standard Time (PST), and a user 10 in New York, N.Y., may be using a device 70 at the same time with the internal clock set to 3:00 pm Eastern Standard Time (EST) due to the different time zones. In many cases the clock on the user device 60, 92, 70 may be set according to a local network or internet service provider (ISP) to which the user device 60, 92, 70 is logged into.

One or more servers 40 may include one or server clusters 42 and one or more web front end servers 44. One or more storage devices 250 may further be included. Further, within the server 40, or external to the server 40, one or more network video storage systems 48 may be included. The network video storage system 48 may include a primary or first video database 72 and a secondary or second video database 74. For example, the first video database 72 may store a plurality of first videos that may be downloaded to user devices 60, 92, 70, and the second video database 74 may store a plurality of second videos that may be downloaded to user devices 60, 92, 70 while each user device 60, 92 70 is online.

Once downloaded, the first videos may stored in a relative local first video database 82 and the second videos may be stored in a relative local second video database 84 on a local storage system 62 on each of the user devices 60, 92, 70. As those of skill in the art may recognize, instead of using up internet connection resources during peak usage of the user devices 60, 92, 70, the first and second videos may be downloaded in the background when internet usage of each user device 60, 92, 70 is low.

Once downloaded one or more of the second videos may be presented before, during or after the one or more first videos. By way of example, and not by way of limitation, the first videos may include user searchable videos for presentation to the users, and the second videos may include a plurality of advertising videos that may be presented within the presentation of the first videos. In one embodiment, instead of the first and second videos being stored in two databases, both the first and second videos may be stored in the same database, but, for example, in different database files or folders for organizational purposes.

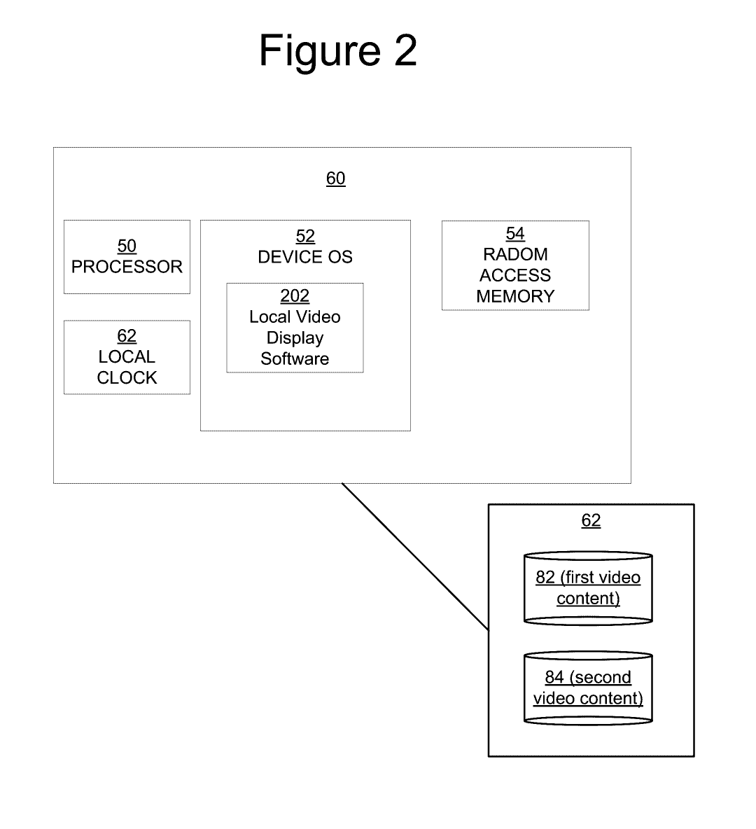

With reference to FIG. 2, a diagrammatic representation of the internal components of one or more of the user devices 60 (92, 70 in FIG. 1) is shown. As those skilled in the art would recognize, each user device 60, 92, 70 may include a processor 50, on which executable instructions of an app or computer program 202 may execute. As those skilled in the art would recognize, the computer program, which may embody the video display software 202, may be loaded by an operating system 52 running on each user device 60, 92, 70. Further, the user devices 60, 92, 70 may each have a random access memory (RAM) 54 that may be used for loading programs, and storing program variable data, such as an online-offline flag 204 used by the video display software 202 to keep track of when the user device 60, 92, 70 is online or offline for downloading and upload data as explained above.

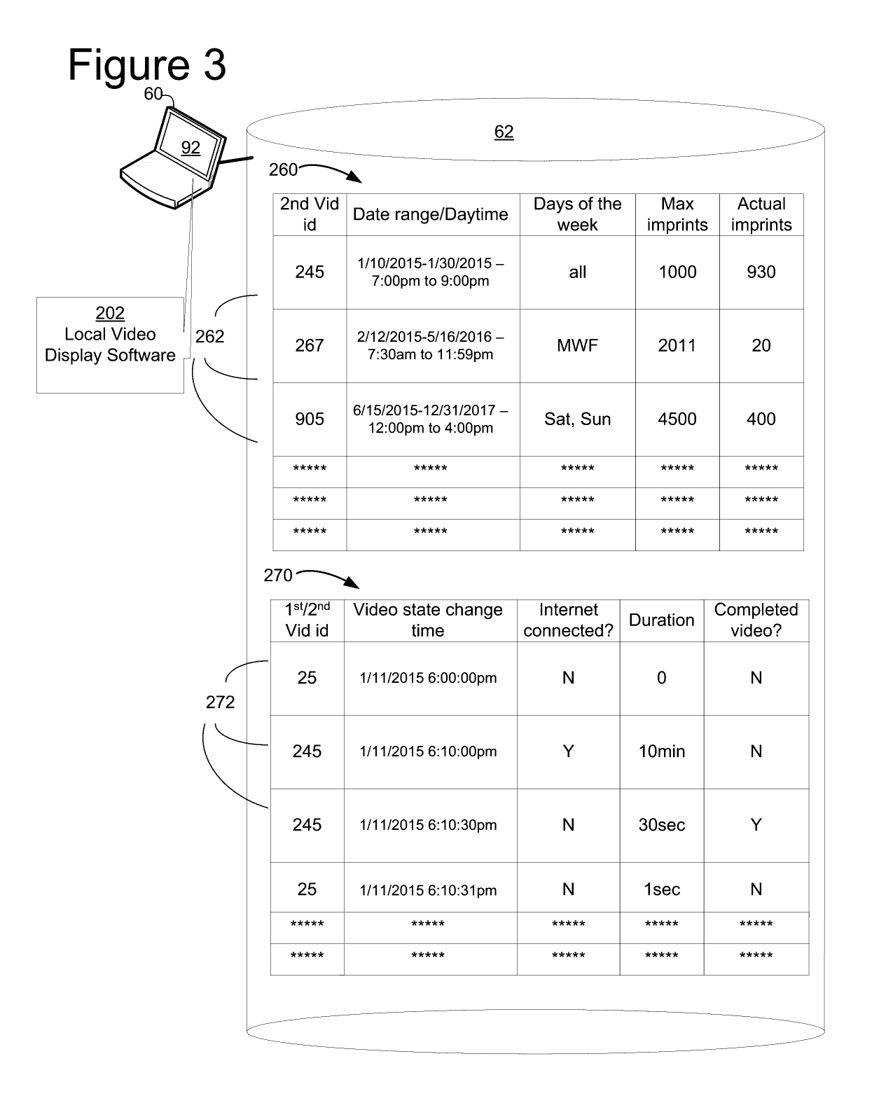

With reference to FIG. 3, a diagrammatic representation of the one or more user devices 60 (92, 70 in FIG. 1), and the storage device 62, is shown. As indicated above, each user device 60, 92, 70 may have executing within it video display software 202. The video display software 202 may comprise instructions to retrieve and display videos from the local first video database 82 according to requests received by users 10. The storage device 62 may store one or more databases to manage presentation of the second videos with the showing of the first videos. An exemplary database table 260 is shown in FIG. 3 illustrating some of the electronic data that may be stored and transformed to managing second video playback within presentation of the first videos. For example, each record of table 260 may contain second video identification data, date range and time of day parameters to define when the second video should be shown, the days of the week that the second video should be shown, the maximum total impressions of the second video, and the actual impressions so the number of impressions of each second video can be tracked for each user. This can be useful, for example, when the second videos comprise advertisements, and the web server owner is paid for the number of presentations of the second videos to selected user profiles.

In this regard, the web server owner, or owners of the second videos, may require that certain second videos be shown at certain number of times to each or certain users 10, and thus, included in each record 262 of the table 260 may be an impression or shown count field for each video identifier identified in a second video identifier field. This and other data in the record 262 may be referred to as consumption metadata.

Further, other tables may be included, by way of example, and not by way of limitation, a table 270 for storing online/offline status during 1^{st} video and 2^{nd} video playback. During video playback, it may be desirable to detect, store, and upload the online status data to the server (40 in FIG. 1) to store in a database in storage device (250 in FIG. 1) when the user device 60 is online. In this regard, each record 272 of the online status table may contain a field for the 1^{st} video or 2^{nd} video identifier for the video being played starting at a time recorded in the video state change field. The online/offline status may be recorded for that time in an internet connected status field. The duration between recorded state changes may be stored in a duration field. Further, a video completed field records whether the video was completed for the specified state change.

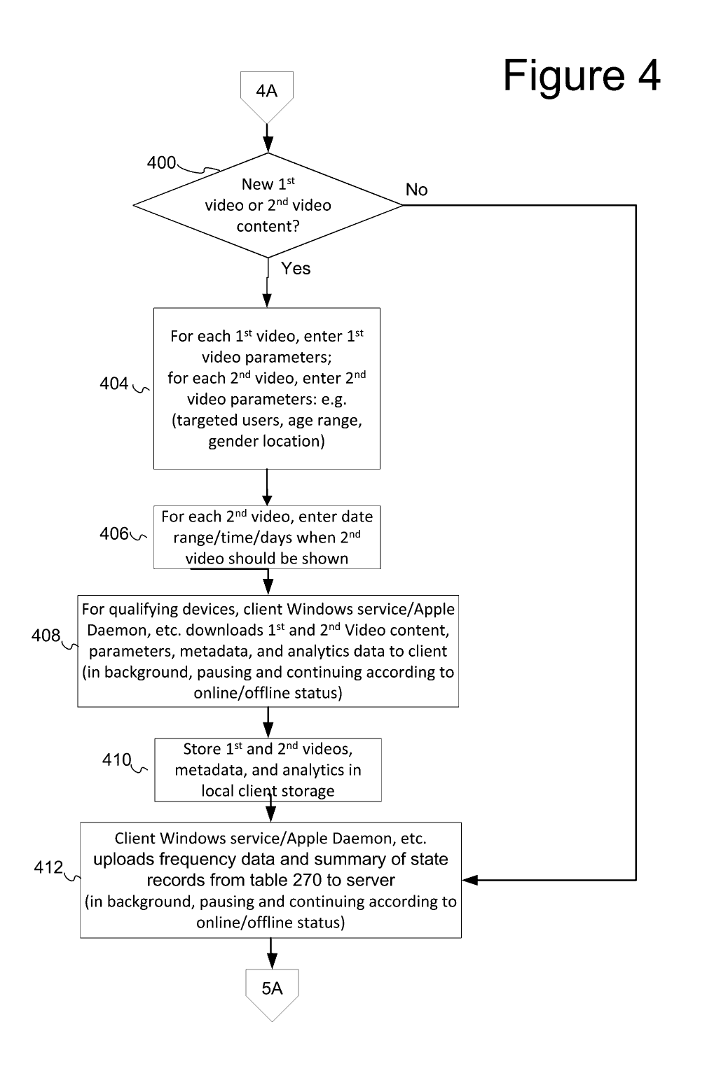

With reference to FIG. 4, a flow chart illustrating steps performed by the video display software 202 according to the embodiment of FIGS. 1-3 is shown. In step 400, it is determined whether new 1^{st} or 2^{nd} video content needs to be added to the network video storage system 48. If so, then in step 404, parameters for the 1^{st} and 2^{nd} videos that are added to the network video storage system 48 in storage device 250, as the 1^{st} and 2^{nd} videos are added to video storage devices 72 and 74. The second video parameters that may be entered in to storage device 250 may include, by way of example, and not by way of limitation, parameters for the targeted users, such as age range, gender, geographic region, and the like. In step 406, parameters for the second videos relating to the date range/times/days when each second video should be shown may be entered into storage device 250. In step 408, for qualifying devices, the client Windows service/Apple daemon, or the like for the particular device, downloads (pulls) 1st and 2nd video content, parameters, metadata, and analytics data to the user device 60, 92 70 (in background, pausing and continuing according to online/offline status).

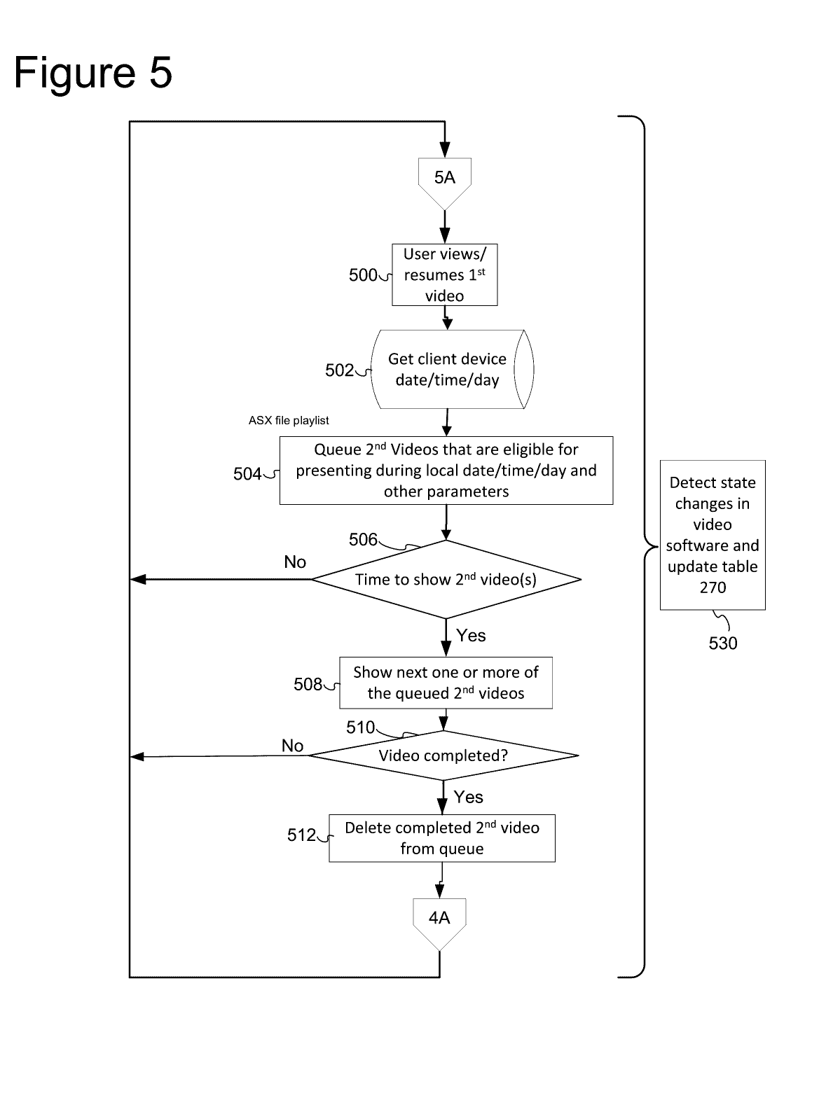

In step 410, as the user device 60, 92 70 receives the data downloaded by the Windows service/Apple daemon, the 1^{st} and 2^{nd} videos may be stored in local video storage folders or disks 82 and 84 within local storage device 62 respectively. In step 412, the client Windows service/Apple Daemon, or equivalent for the device, uploads a summary of state records from table 270 to the server 40 for storage in database 250. Processing moves to FIG. 5.

With reference to FIG. 5, a flow chart illustrating steps performed by the video display software according to the embodiment of FIGS. 1-4 is shown. In step 500, a user may begin or resume viewing one of the first videos. In step 502, a library call or procedure call (i.e. in the .NET framework for example) may be used to determine the locale device system date and time (and therefore day of the week). Further, in step 504, a queue containing pointers to the 2nd videos that are eligible for presenting according to the parameters, including the local date/time/day obtained in step 502. The queue may be prioritized, for example, according to the econd videos for which the required number of impressions are due within the time frame for the second video to be shown, and other prioritizations.

In step 506, the local video display software may check for whether, according to video 1 parameters, it may be time to show one or more of the 2^{nd} videos referred to in the queue. If so, then in step 508, the next one or more second videos are shown. In step 510, the local video display software determines whether each second video is completed. If so, in step 512, each completed 2^{nd} video may be removed from the queue. Processing then moves back to step 400 in FIG. 4.

It should be noted that the local video display software 202 may not comprise its own video player. For many reasons regarding compatibility, it may be more advantageous to show first and second videos in the native video display software as part of the operating system. For example, Windows may use the Windows Media Player® as the standard video play software. This may present a problem with respect keeping track of display actions in the standard video window of the display software. Thus, in step 530 of FIG. 5, the local video display software 202 may detect state changes in video software and update table 270 of FIG. 3.

Upon detection of a state change in presenting the first or second video, the local video display software 202 may read the system date and time, the internet connection state, and the current duration time for the play of the video and therefore whether the currently playing video has completed or not (by comparing the duration of the current video to the current duration of playing time). Thus, in step 530 of FIG. 5, the local video display software 202 then transforms the data in data table 270 to reflect this information.

It should be noted that while examples related to advertisement-type videos may have been used, those of skill in the art may now recognize that many types of second videos may be presented using embodiments described here. By way of further example, and not by way of limitation, the second videos may comprise public service announcements, AMBER ALERTS, or other useful content. As a further example, the second videos may be related to the first videos, for example providing information on product placements in the first videos, or further information about actors, plots, or characters in the first videos.

### The Server

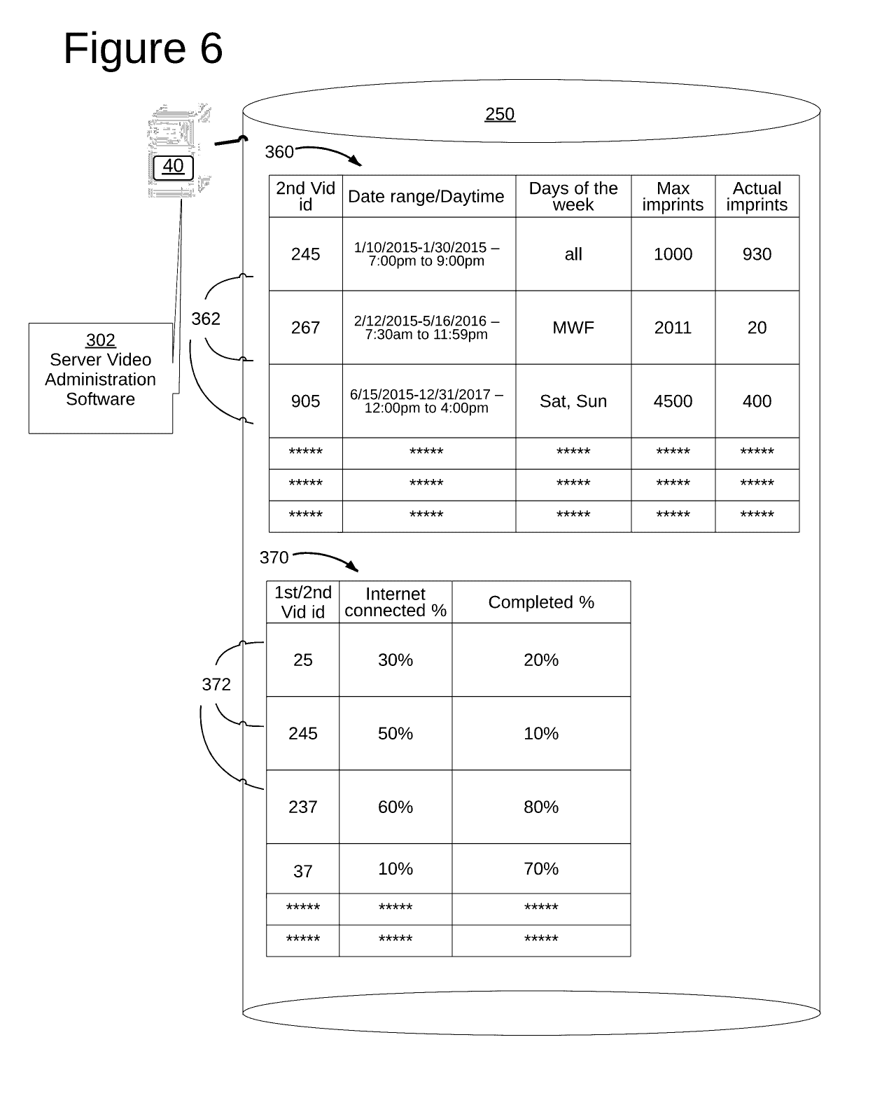

With reference to FIG. 6, a diagrammatic representation of a server device 40, and the storage device 250, is shown. The server device may have a processor that may execute video administration software 302. The video administration software 302 may comprise instructions to administrate the server video database. The server storage device 250 may store one or more database tables 360 and 370 to manage administration of the second videos with the showing of the first videos. An exemplary database table 360 is shown in FIG. 3 illustrating some of the electronic data that may be stored and transformed to managing second video playback with presentation of the first videos after the information and videos are downloaded from the server 40 as described above. For example, each record of table 360 may contain second video identification data, date range and daytime parameters to define when the second video should be shown, the days of the week that the second video should be shown, the maximum total impressions of the second video, and the actual impressions so the number of impressions of each second video can be tracked for each user after data upload from each user device 60, 92, 70.

In this regard, the server 40 may be synchronized with the records in the databases 260 of the user devices 60, 92, 70. As with the databases 260 in the client devices, included in each record 362 of the table 360 may be an impression or shown count field for each video identifier identified in a second video identifier field. This and other data in the record 262 may be referred to as consumption metadata.

However, unlike database 260, the database 360 may further include a field for the number of unique users that may be designated to have their device download a certain video. The number of unique users may be a function of, by way of example and not by way of limitation, a contract with an advertiser in embodiments wherein the second videos comprise advertisements. Instructions downloaded to each user device 60, 92, 70 may be configured to only download second videos designated as one of the unique users that are designated to receive specified videos for the user according to parameters. Once a the threshold of the number of unique users for each second video is met as far as downloading to the user devices 60, 92, 70, then the video is no longer designated to be downloaded by the executable instructions. This provides reach control for each video, without the need for a local cookie or user authentication, while ensuring that each user that receives the second video on their user device 60, 92, 70 is a unique user.

Further, other tables may be included, by way of example, and not by way of limitation, a table 370 for storing online/offline status data uploaded from the user devices 60, 92, 70 during 1^{st} video and 2^{nd} video playback previously described. In this regard, each record 372 of the online status table may contain a field for the 1^{st} video or 2^{nd} video identifier for the first and second videos that are being played by users on their devices 60, 92, 70. The online/offline percentage field stores the percentage of time online and offline during presenting of the relevant video. This statistic may help, for example, to give marketing information to potential advertisers in embodiments where the second videos may comprise advertisements. Another field may comprise a video completed percentage field so that uploaded statistical data on the percentage of times the users completed watching the first and second videos may be stored in table 372.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A system for frequency control when presenting digital content, comprising:
a server processor on a server device;
a server storage device connected to the server device;
a first set of executable instructions that are executable on the server processor configured to provide digital content stored on the server storage device to one or more user devices that are connected to a network, the first set of executable instructions further configured to store one or more parameters for presenting the digital content, the one or more parameters including frequency control parameters;
a second set of executable instructions configured to be downloaded to each of the user devices to store the frequency control parameters on a client storage device for each user device, wherein the frequency control parameters are configured to be updated by the second set of downloaded instructions upon presentation of the digital content on the user devices regardless of whether the digital content is presented online or offline with respect to the network; and
a third set of executable instructions configured to synchronize the frequency control parameters with each of the user devices, the second set of executable instructions further configured to synchronize the frequency control parameters when online.

2. The system of claim 1, wherein the second set of executable instructions are configured to present or not present the digital content based on the frequency control parameters.

3. The system of claim 1, wherein the digital content comprises a video.

4. The system of claim 1, wherein the digital content comprises a first and second video.

5. The system of claim 2, wherein the first video comprises a video selected by a user for playing.

6. The system of claim 3, wherein the second video comprises an advertisement video that is shown with the first video based on the one or more parameters.

7. The system of claim 1, each user device further comprising a daemon for downloading the digital content.

8. A method for frequency control when presenting digital content, comprising:
providing digital content stored on the server storage device to one or more user devices that are connected to a network
storing one or more parameters for presenting the digital content, the one or more parameters including frequency control parameters;
downloading instructions executable each of the user devices to store the frequency control parameters on a client storage device for each user device, wherein the frequency control parameters are configured to be updated by the set of downloaded instructions upon presentation of the digital content on the user devices regardless of whether the digital content is presented online or offline with respect to the network; and
synchronizing the reach and frequency control parameters with each of the user devices, the second set of executable instructions further configured to synchronize the frequency control parameters when online.

9. The method of claim 8, wherein the downloaded set of executable instructions are configured to present or not present the digital content based on the frequency control parameters.

10. The method of claim 8, wherein the digital content comprises a video.

11. The method of claim 8, wherein the digital content comprises a first and second video.

12. The method of claim 8, wherein the first video comprises a video selected by a user for playing.

13. The method of claim 12, wherein the second video comprises an advertisement video that is shown with the first video based on the one or more parameters.

14. The method of claim 8, further comprising downloading the digital content using a daemon.

15. A system for reach control when presenting digital content, comprising:
a server processor on a server device;
a server storage device connected to the server device;
a first set of executable instructions that are executable on the server processor configured to provide digital content stored on the server storage device to a quantity of user devices that are connected to a network, the quantity of user devices based on a reach control parameter; and
a second set of executable instructions configured to be downloaded to each of the user devices to present the digital content on the user devices regardless of whether the digital content is presented online or offline with respect to the network.

16. The system of claim 15, wherein the digital content comprises a video.

17. The system of claim 16, wherein the digital content comprises a first and second video.

18. The system of claim 17, wherein the first video comprises a video selected by a user for playing.

19. The system of claim 18, wherein the second video comprises an advertisement video that is shown with the first video based on one or more parameters.

20. The system of claim 15, each user device further comprising a daemon for downloading the digital content.

21. A method for reach control when presenting digital content, comprising:
providing digital content stored on a server storage device to a quantity of user devices that are connected to a network, the quantity of user devices based on a reach control parameter; and
downloading a set of executable instructions to each of the quantity of user devices to present the digital content on the user devices regardless of whether the digital content is presented online or offline with respect to the network.

22. The method of claim 21, wherein the digital content comprises a video.

23. The method of claim 22, wherein the digital content comprises a first and second video.

24. The method of claim 23, wherein the first video comprises a video selected by a user for playing.

25. The method of claim 24, wherein the second video comprises an advertisement video that is shown with the first video based on one or more parameters.

26. The method of claim 25, further comprising downloading the digital content.
